(19) United States
(12) Patent Application Publication
(10) Pub. No.: US 2005/0241916 A1
(43) Pub. Date: Nov. 3, 2005

(54) Apparatus for conveying fruits and vegetables

(76) Inventor: Paolo Gentili, Trento (IT)

Correspondence Address: NIXON & VANDERHYE, PC, 901 NORTH GLEBE ROAD, 11TH FLOOR, ARLINGTON, VA, 22203, US

(21) Appl. No.: 10/520,361

(22) PCT Filed: Jul. 8, 2003
(86) PCT No.: PCT/IB03/02708

§ 371 Date: Jan. 6, 2005

(30) Foreign Application Priority Data
Jul. 9, 2002 (IT) MO2002A000199

(51) Int. Cl. B65G 65/46; B65G 47/18

(52) U.S. Cl. 198/545

(57) ABSTRACT

An apparatus for conveying fruit and vegetable products, for example grapes, comprises a hopper device suitable for receiving said products and a screw-feeder arrangement suitable for conveying said products towards an outlet zone, said screw-feeder arrangement having variable pitch. It is further provided a method for conveying fruit and vegetable products, for example grapes, comprising using a variable pitch screw-feeder arrangement.

The invention concerns an apparatus for conveying fruit and vegetable products, particularly grapes, from a loading zone to an unloading zone in which the products will be further processed.

In winemaking it is already known to unload the grapes that have been deposited in trailers of tractors after been harvested, inside a hopper.

At the base of the hopper is provided a screw-feeder which ensures, by the rotation around its own axis, that the mass of grapes is shifted from the bottom of the hopper towards an outlet hole.

During rotation of the screw-feeder, also the grapes that are immediately above the screw-feeder are conveyed towards the outlet zone, not only the grapes that are directly in contact with the screw-feeder.

In fact, the bunches contained in the screw-feeder are stacked with the bunches above them, thus dragging the latter towards the outlet zone.

The mass of grapes that is not inside the screw-feeder but is nevertheless conveyed towards the outlet zone, accumulates against the wall in which the outlet hole is obtained, without leaving the hopper.

The excess grapes violently knock against the wall in which the outlet hole is obtained, and it is thoroughly cut when a part of the grapes comes out towards the unloading zone, but the remaining part remains confined into the hopper.

The grapes, therefore, undergo traumatic actions, that cause consequent extraction of the sap from the stalks and from the skin of each grape, this negatively affecting the properties and the final quality of the wine to be obtained.

A further drawback of the state of the art is due to the large piles of grapes that accumulate, for the reasons above-explained, near the outlet wall of the hopper.

Very high pressures develop where the grapes accumulate, and can happens that whilst the mass of grapes arranged near the screw-feeder is conveyed towards the outlet zone, the mass of grapes arranged above is so pressed against the side walls of the hopper to can not descend towards the screw-feeder.

Are thus created ‘bridges’ of pressed grapes that prevent the screw-feeder from being fed and that can be removed only by the manual intervention of the operator.

A yet further drawback of the state of the art is due to the fact that, owing to the high pressure and the traumatic action exerted on the grapes inside the hopper, at this zone of the apparatus, the grapes are already partially pressed and consequently must is formed.

Said must subsequently goes on to the incidental stalk-remover arranged downstream the hopper for separating the individual grapes from the stalks. If, in this phase, an excessive quantity of must is produced, only a part of the must may flow out through the stalk-remover, passing through a plurality of holes obtained on a cylindrical shell of the stalk-remover through which can exit the individual grapes but not the stalks. The remaining part of the must is dragged towards the outlet of the stalk-remover together with the stalks to be eliminated and is therefore lost.

One object of the invention is to improve the apparatuses for conveying fruit and vegetable products, particularly grapes.

A further object is to provide apparatuses for conveying fruit and vegetable products in which said products are treated in a soft and non-traumatic manner.

A further object of the invention is to provide apparatuses for conveying fruit and vegetable products that, during operation, require limited interventions by an operator.

A yet further object of the invention is to provide apparatuses for conveying fruit and vegetable products that do not cause excessive separation between solid and liquid parts of said products at the outlet of the apparatus.

In a first aspect of the invention, is provided an apparatus for conveying fruit and vegetable products, particularly grapes, comprising hopper means suitable for receiving said products and screw-feeder means suitable for conveying said products towards an outlet zone, characterised in that said screw-feeder means has a variable pitch.

In one advantageous embodiment, the pitch of the screw-feeder means is growing proceeding towards said outlet zone.

The screw-feeder with variable pitch means ensures that the product is processed in different ways inasmuch as the quantity of products moved by the greater pitch portions of the screw-feeder means is greater than the quantity of products moved by the lesser pitch portions.

Providing screw-feeder means with a pitch growing towards the outlet zone, it is possible to pick up from the regions of the hopper means near the outlet zone a quantity of product that is greater than the quantity picked up from the regions of the hopper means that are farer from said outlet zone. In this way, accumulation of the products in the hopper means near the outlet zone, and the ‘bridge’ effect are avoided. Furthermore, is ensured a non-traumatic treatment of the fruit and vegetable products, which are not subjected to excessive pressure or to cutting actions.

In a second aspect of the invention, is provided the use of screw-feeder means with variable pitch for conveying fruit and vegetable products, particularly grapes.

Thanks to this second aspect, transport of the fruit and vegetable products can be improved without the latter leading to undesirable accumulations or being subjected to excessively harsh treatment.

The variable pitch screw-feeder means can also be used in prior-art apparatuses for conveying fruit and vegetable products replacing the constant pitch screw-feeders of the state of the art.

This enables to transform the known apparatuses into efficient apparatuses that do not have the above-listed drawback, with limited investments and reduced installation times, inasmuch as it is not necessary to replace the entire apparatus but only the screw-feeder means thereof.

In order that the invention may be clearly and completely disclosed, reference will now be made, by way of examples that do not limit the scope of the invention, to the accompanying drawings, in which:

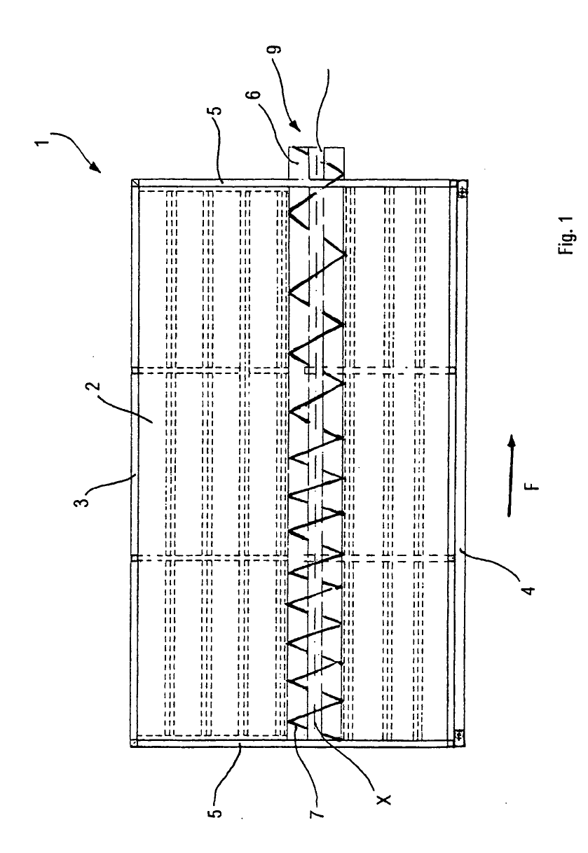

FIG. 1 is a view from above of the apparatus according to the invention;

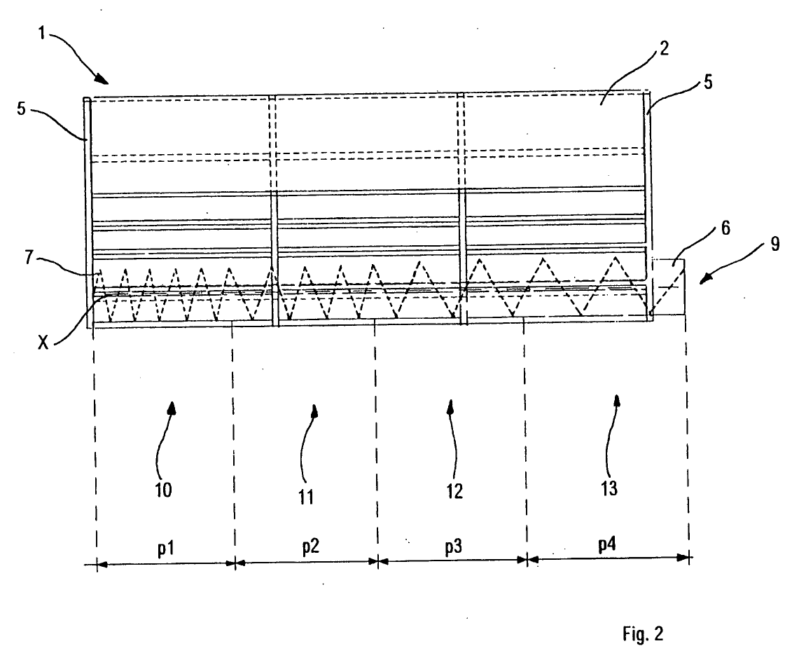

FIG. 2 is a front view of the apparatus according to the invention;

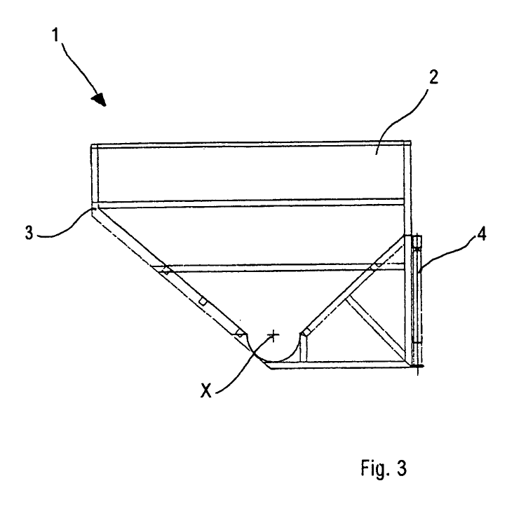

FIG. 3 is a side view of the apparatus of FIG. 1.

FIGS. 1 and 3 show an apparatus 1 for conveying fruit and vegetable products, in particular grapes, in a conveying direction F towards an outlet zone 9.

The apparatus 1 comprises a hopper 2 suitable for receiving grapes unloaded from tractors whereupon they were deposited after being harvested in the vineyards. The hopper 2 is delimited in a direction parallel to the conveying direction F by a fixed wall 3 and by a hinged side 4 that is opened and folded downwards when the grapes have to be unloaded from an arriving tractor. The hopper 2 is furthermore delimited, in a direction transversal to the conveying direction F, by two fixed panels 5.

At the bottom part of the hopper 2 there is provided a screw-feeder 6 comprising a helical surface 7 that winds on a shaft 8 extending along a longitudinal axis X.

The screw-feeder 6 is provided with a variable pitch, in particular a pitch growing towards the outlet zone 9.

In a preferred embodiment, shown in FIG. 2, can be identified in the screw-feeder 6 different zones having different pitches from one another. In particular, starting from the fixed panel 5 farer from the outlet zone 9, can be identified a first portion 10 of the screw-feeder 6 having a first value p1 of pitch about of 200 mm. Subsequently can be identified a second portion 11 in which the pitch has a second value p2, comprised between 200 and 250 mm, and a third portion 12 in which the pitch has a third value p3 of about 300 mm. Finally, near the outlet zone 9, can be identified a fourth portion 13 of the screw-feeder 6 in which the pitch has a fourth value p4, of 400 mm. Experimental tests have shown that these values enable the fruit and vegetable products to be conveyed in an optimal manner towards the outlet zone 9, using a screw-feeder 6 having an external diameter of about 400 mm.

Motor means, not shown, is also provided in order to actuate the rotation of the screw-feeder 6.

After the grapes to be transformed into wine have been harvested, they are brought by tractors up to the hopper 2; said tractors stop on a plate connected to weighing means to determine the weight of the harvested product.

The hinged side 4 of the hopper 2 has been previously folded downwards to facilitate the entry of the grapes. After the tractor has been made integral with the above-described plate by means of chains, said plate is tilted so that the grapes contained in the trailer pass directly into the hopper 2.

At this point, the variable pitch screw-feeder 6 is rotated by the motor means in such a way as to direct the grapes towards the outlet zone 9. As the quantity of grapes conveyed by the screw-feeder 6 is proportional to the pitch of the screw-feeder 6, the lesser pitch portions convey a smaller quantity of grapes than those conveyed from the greater pitch portions. The quantity of grapes picked up from regions far from the outlet zone 9 is therefore less than the quantity picked up from regions near said outlet zone 9, and this avoids great accumulations of grapes to be formed near the outlet zone 9.

The grapes leaving the hopper 2 can be feed into a known stalk-remover in which the individual grapes are separated from the stalk, before being directed to the subsequent phases of the vinification process.

Apparatuses for conveying fruit and vegetable products, particularly grapes, of the known type with a screw-feeder having a constant pitch can rapidly be converted into apparatuses like those described in FIGS. 1 to 3 by simply replacing the constant pitch screw-feeder with a variable pitch screw-feeder similar to the screw-feeder 6.

1-16. (canceled)

17. Apparatus for conveying fruit and vegetable products, for example grapes, comprising a hopper device suitable for receiving said products and screw-feeder arrangement suitable for conveying said products towards an outlet zone, wherein said screw-feeder arrangement has a variable pitch.

18. Apparatus according to claim 17, wherein said pitch grows going towards said outlet zone.

19. Apparatus according to claim 17, wherein can be identified in said screw-feeder arrangement, portions, each one of which corresponds to a given value of said pitch.

20. Apparatus according to claim 19, wherein said portions comprise a first portion, in which said pitch is about 200 mm.

21. Apparatus according to claim 19, wherein said portions comprise a second portion, in which said pitch is comprised between 200 mm and 250 mm.

22. Apparatus according to claim 19, wherein said portions comprise a third portion, in which said pitch is about 300 mm.

23. Apparatus according to claim 19, wherein said portions comprise a fourth portion, in which said pitch is about 400 mm.

24. Apparatus according to claim 17, wherein said screw-feeder arrangement is arranged below said hopper device.

25. Apparatus according to claim 17, wherein said hopper device comprises a hinged side element.

26. Method for conveying fruit and vegetable products, for example grapes, comprising using a variable pitch screw-feeder arrangement.

27. Method according to claim 26, wherein said screw-feeder arrangement has a variable pitch growing along a conveying direction of said products.

28. Method according to claim 26, wherein can be identified in said screw-feeder arrangement, portions, each one of which corresponds to a given value of said pitch.

29. Method according to claim 28, wherein said screw-feeder arrangement has portions comprising a first portion, in which said pitch is about 200 mm.

30. Method according to claim 28, wherein said screw-feeder arrangement has portions comprising a second portion, in which said pitch is comprised between 200 mm and 250 mm.

31. Method according to claim 28, wherein said screw-feeder arrangement has portions comprising a third portion, in which said pitch is about 300 mm.

32. Method according to claim 28, wherein said screw-feeder arrangement has portions comprising a fourth portion, in which said pitch is about 400 mm.
